(19) United States
(12) Patent Application Publication
(10) Pub. No.: US 2015/0065171 A1
(43) Pub. Date: Mar. 5, 2015

(54) PROVIDING PERTINENT INFORMATION TO USER

(71) Applicant: Yash Huilgol, San Diego, CA (US)

(72) Inventor: Yash Huilgol, San Diego, CA (US)

(21) Appl. No.: 14/016,122

(22) Filed: Sep. 1, 2013

(51) Int. Cl. H04W 4/02

(52) U.S. Cl. CPC H04W 4/02
USPC 455/456.3

(57) ABSTRACT

Techniques for providing location based information to users of wireless devices include, receiving, from the wireless device, a request for a web page; and providing, the web page to the wireless device, wherein the web page includes information specific to a location of the wireless device and wherein the location-specific information is provided without receiving a location signal from the wireless device.

### TECHNICAL FIELD

This patent document relates to wireless communication and in particular to providing information to users of mobile devices.

### BACKGROUND

For many users, direct access to a webpage with information via the internet in an unfamiliar location (such as the outdoors) is a difficult task, especially if they need to plan their journey from their present location. With advances in cellular network technologies, the access to the internet or satellite reception is ubiquitous, but the ability to find important information and pertinent information to the visitor in such a place with speed and efficiency is difficult. The data retrieved needs to be quickly retrieved and highly localized, and information near a geographical area tends to be based on advertiser's information and distances to a commercial location, as opposed to information necessary for the viewer in an outdoor setting. In some present day technologies such as Global Positioning System (GPS) navigation, applications are provided for retrieving limited navigational information such as street maps and nearby businesses (e.g., stores, food places, etc.).

### SUMMARY

Techniques for providing information to wireless users are disclosed. An information server is made aware of a user's location by a message generated from the user's wireless device. The message includes user's location information that may not depend on the user's Global Positioning System (GPS) location information or location information generated by the mobile devices' operator using techniques such as triangulation. In one embodiment, the position information is inferred from a short range scan of a visual marker available at the location of the user. Based on the location of the user, information is provided to user about hiking trails, public facilities, and points of interest for a hiker, etc. In some embodiments, for the same latitude/longitude (e.g., GPS) location, different information is provided to a user based on his elevation. The information system may infer the user's elevation based on a visual marker information conveyed by the user's mobile device to the information system using, e.g., a near field communication scan performed by the user's mobile device with an on-location visual marker such as a bar code.

In one example aspect, a method of accessing information in an unfamiliar location using readily available wireless infrastructure, and providing a method of combining disparate technologies into a single application, following the steps of: Configuring a physical or virtual marker accessible to a visitor in the area; Allowing a user access to information from the mobile device; Providing the user's device location-pertinent information. The step of providing user information comprises of providing the information without an explicit request from the user. The method provides the user with pertinent information wirelessly and directly prior to and on location, to plan their experience, without the user's active effort, and provides relevant resources such as points of interest and trail information quickly and efficiently, allowing information to be manually or automatically retrieved to the user. It configures a system that, even without a knowledge of a user's geographic presence, is still be able to provide information but streamlines all information into pertinent information, providing only important and significant data that is of use to the user at that point. The information presented online for viewing is able to be edited online, and allow the changes to be reflected when the user accesses the information. And, all three steps can be used as a method to access the following, not limited to: visitor/user safety information, distance to a point of interest, interpretive programs, trailhead information, trail closures, and Weather warnings.

The subject technology can also be implemented as a method of enhancing the granularity of the GPS, including information not provided by the GPS database, and supplementing information to the user at a location without preexisting corresponding information, following the steps: Creating a file that is accessible online that is able to be downloaded to a GPS by a user, both wirelessly or through a cable connection; Enabling the GPS, based on a user's location and the information on the file, to provide further information regarding the points of interest. The method also provides information to the user without an explicit request from the user, which gives the user the option to view data that supplements the GPS's built-in data files. The file can supplement built-in geographic data of the GPS to enable the user to access more localized data from the internet on their mobile device, without requiring internet connection to access this online information. This system is able to be expanded to not only outdoor uses, but for any location that does not provide information to user at more localized and specific locations without information markers, including but not limited to shopping malls, museums, buildings, and can later supplement data already presented on a GPS, for example in the X-Y (two-dimensional) coordinate plane with information presented at elevations on the X-Y-Z (three-dimensional) coordinate plane giving the creator flexibility and the ability to modify and update the file with current features that are necessary of the device and provided because of the user's need.

### BRIEF DESCRIPTIONS OF THE DRAWING

FIG. 1 is a schematic illustration of one on-site embodiment, involving a user in an outdoor setting using a mobile cellular device to access information; and,

FIG. 2 is a schematic illustration of another embodiment, involving a user that is using a GPS device to view the virtual information in an outdoor setting; and,

FIG. 3 is a flow chart diagram describing the method of accessing pertinent information in an outdoor setting; and,

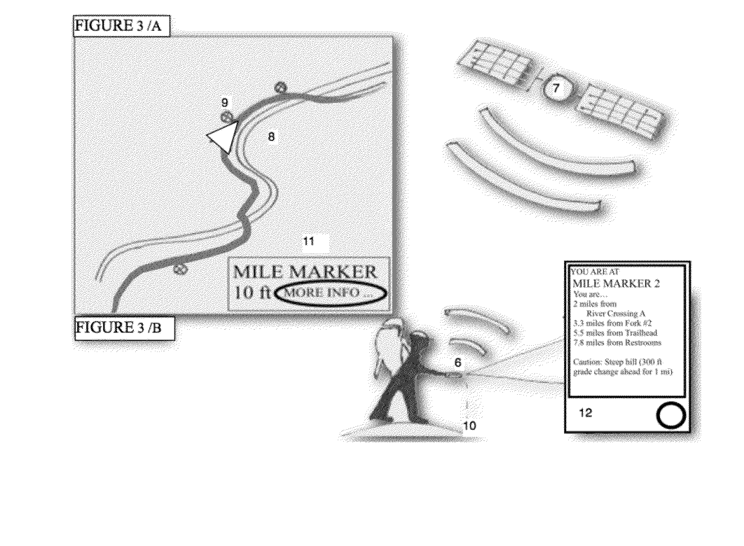

FIG. 4 is a visual depiction of the first embodiment, with a sign depicted with a visual code depicted on the trail marker; and,

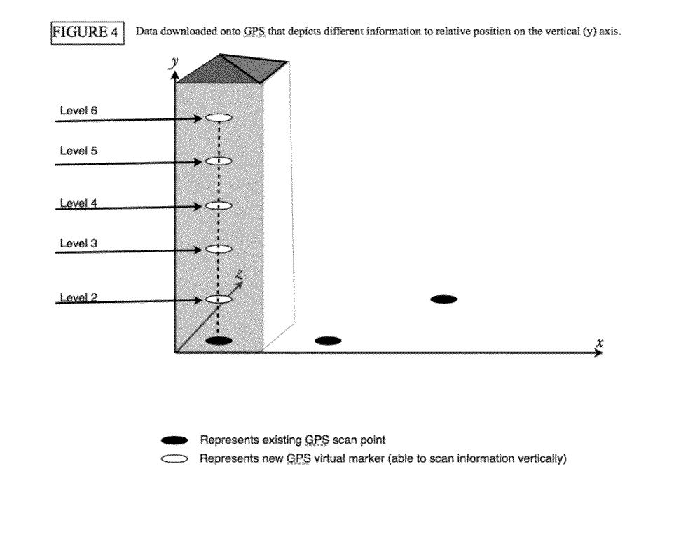

FIG. 5 is a depiction of the GPS system being able to depict information not only along the X and Y axis (horizontally) but also in the third dimension vertically (Y axis); and,

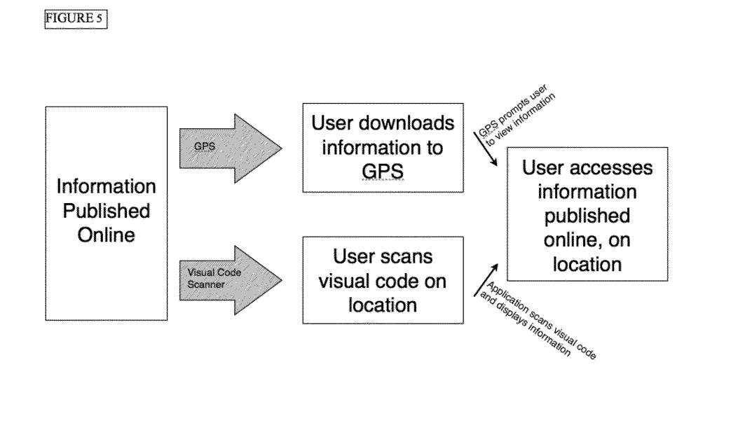

FIG. 6 is a schematic illustration of another embodiment, involving a user in a shopping mall using gestures in a vicinity of a marker to download information to a cell phone

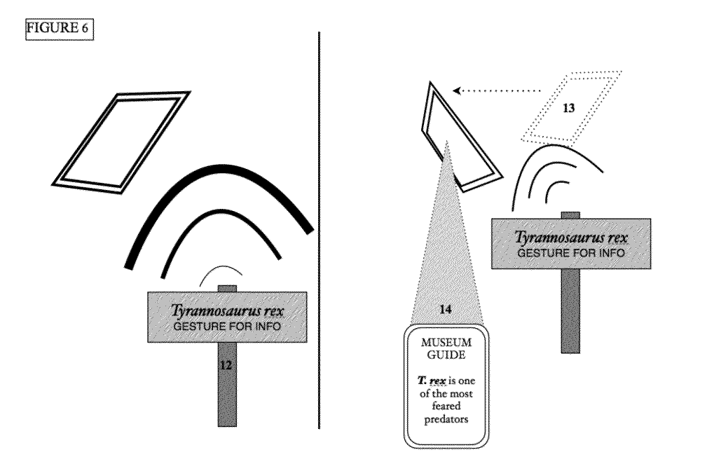

### DETAILED DESCRIPTION

For many users, direct access to a webpage with information via the internet in an unfamiliar location is a difficult task, especially if they need to plan their journey from their present location. With advances in cellular network technologies, the access to the internet or satellite reception is ubiquitous, but the ability to find important information and pertinent information to the visitor in such a place with speed and efficiency is difficult. The data retrieved needs to be quickly retrieved and highly localized, and information near a geographical area tends to be based on advertiser's information and distances to a commercial location, as opposed to information necessary for the viewer in an outdoor setting. In adequacies of the prior art includes the retrieving of data not from a source to provide pertinent information at that very point where the user is, but from an advertiser's database, which provides the user with unnecessary information. Furthermore, the use of the current prior art primarily provides the user with information on streets, which are not as helpful for the user in an outdoor setting.

Existing techniques provide the user with information pertaining to advertising and marketing, with lesser applications to aid visitors with information in an outdoor, recreational setting. Many inventions exist in commercial applications, such as marketing and business, trade and advertising. This would be the first technique to truly provide a system for the viewer to access pertinent information via the three formerly separate technologies into a unified application, in an outdoor setting.

The present document describes, in one aspect, an application of applying wireless technology to provide information to a user who is in an outdoor setting. The embodiment may make the use of cellular technology, the internet and advances in data transmission in enabling the visitor to view location-pertinent information to nearest trailheads or mile markers) using a mobile device-identified virtual or physical marker, that allows the mobile device to be automatically connected to the internet, and provide data to the user.

In certain embodiments, you can implement this with three components: the mobile device, which connects wirelessly to the internet, cellular network or a satellite to receive data after a visual cue from the visual or virtual marker; the visual marker, which provides a physical presence for the user to be able to identify a location to access the information; and finally, the user, who is able to access the data through the screen of the mobile device.

The mobile device connects wirelessly to the internet or satellite, whether it be through a Global Positioning System Device (GPS), a cellular phone or otherwise a handheld, WiFi accessible device. Any device can be used by the user, so long as they are able to access a wireless source.

The visual marker is a physical or virtual installment that allows the user to identify a point of data transfer. For cell phone access, the visual marker can be similar to a visual matrix Quick Response Code link, barcode or for GPS systems, can be a virtual map that contains the markers at specific points at the locations. When creating such a visual or virtual marker, one can use an off-the-shelf code generator that configures a code to link to a specific webpage automatically when scanned by a visual scanner. Although this is not the only way a to create such a marker, modifications can be made to provide a better experience for the user, by either manually or automatically (using a visual code generator) configuring a code to make the data presented direct to a video or enlarge text to make it mobile device-friendly, etc.

The data presented includes the location-pertinent information, like points of interest like local flora, fauna, historical monuments, natural landscapes and formations, etc. The information also presented can be relevant distances to trailheads, trail junctions, detours and other trail occurrences that the user can potentially come across and require information for. The fast and direct access to this data is found by allowing a user access to information from the mobile device through means of a visual marker that has a definite location, then providing the user's device location-pertinent information based on that localized marker

This application also makes it easier for visitors to access information online for visitors and potential users before they arrive at the wilderness: By collecting data online, prospective visitors can access all the relevant information that is published, such as trailhead locations, overall safety and general site information, in a single location, that streamlines both access to the links through the application, but provides a holistic view of all data that is found in that location. Through this, all the data found can be transferred onto a virtual grid that contains various points that are representative of the points in the actual, real-life location, and is easily accessible to a user. Various tools can be used, but the data that is collected can be applied to systems already in place such as interactive maps or custom-built data aggregators. The present systems that exist may include custom data builders, but this application streamlines the method of access to allow the user to quickly navigate information in two ways: before reaching the site as a method of planning moreover as an onsite navigation tool to view pertinent information at a relevant point.

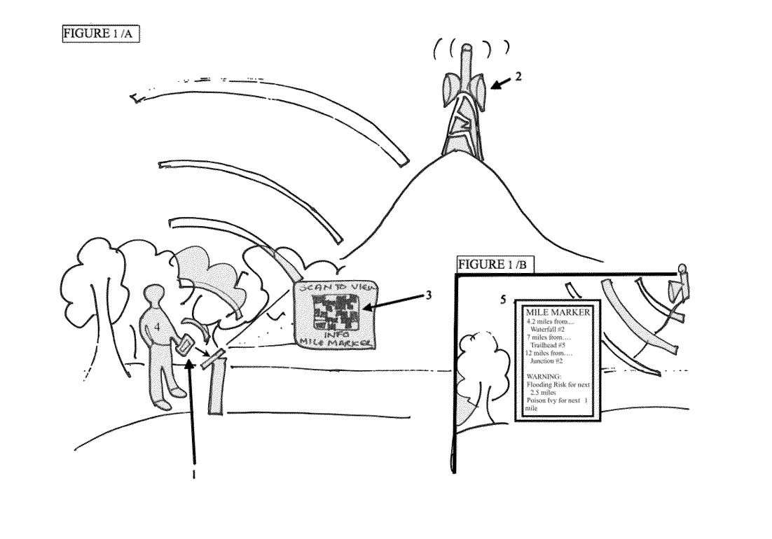

In accordance with the application, a first embodiment (FIG. 1) has three components: the mobile device (1), which connects wirelessly to the internet, cellular network (2) to receive data after a visual cue from the visual or virtual marker (3); the visual marker, which provides a physical presence for the user to be able to identify a location to access the information; and finally, the user (4), who is able to access the data.

When a visitor (the user) visits an outdoor wilderness area with their phone, they are able to scan a visual marker that usually is visible and identifiable (such as a mile marker used in the figure) using either an application on their handheld device or built in software. By scanning a visible “Scan to view information” Quick Response Code or a Barcode, the user enables his device to access the link that is built in to the code. Then, over a wireless network, such as that of their cellular operator, the user is able to access the internet, and retrieve the web page that the visual marker codes for. From then, the user receives the information that has been published to the webpage (5), able to view pertinent information about the area surrounding the user, whether it be locations to points of interests (waterfalls), trailheads or junctions, danger areas with caution warnings (such as areas with poison ivy or flooding risk).

The first embodiment can be efficiently accessed and quickly created, as the built-in internet infrastructure allows the visitor to quickly use the information given using current technologies. The quick and efficient transfer of information can allow the user to carefully plan which direction to go and what he or she wants to do on location. With built in markers in place, the user can proactively scan the codes and manually access the information, if necessary, as an added tool for people to the locations interpretive programs.

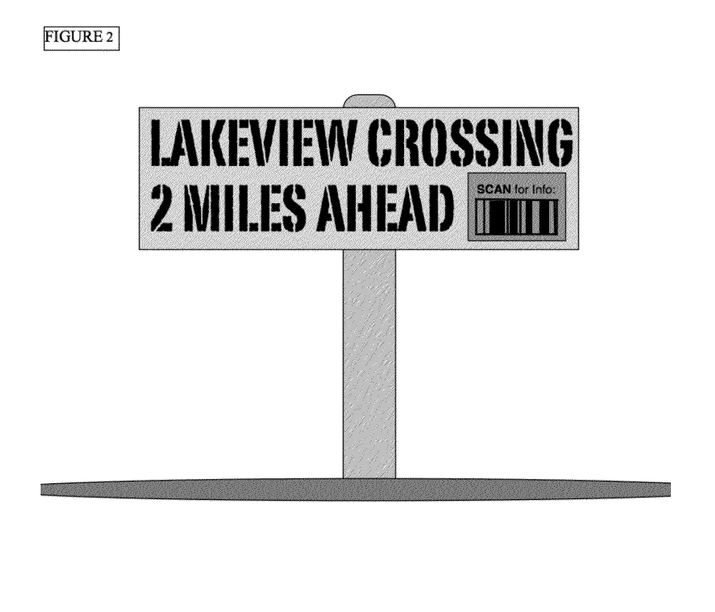

The second embodiment (FIG. 2) of the subject technology has three components as well: the GPS (Global Positioning System) [6] utilized by the user, which connects to a satellite system (7), and data previously downloaded from the internet prior to hiking by the user, which includes all key points of interest depicted on a map (8). As opposed to the previous embodiment, the points of interests depicted are virtual markers only listed on the GPS on a map, not as physical barriers.

The user, who is carrying a GPS, has downloaded the map data provided by the internet depicting the outdoor map with key points of interests. As seen in FIG. 2/A, the user is represented on the coordinate plane as the black arrow, traveling along a red trail approaching a mile marker (depicted on FIG. 2/A as point 9, and FIG. 2/B as point 10, a virtual barrier demonstrating location of mile marker). The GPS starts to depict the amount of distance between the point of interest and the user, which is due to the constant contact between the GPS and the satellite network (7). When in close enough range, the user is prompted and has the option of viewing more information that they downloaded earlier to the GPS (11). The data collected is then displayed on the screen and the internet data can be accessed.

The second embodiment of the subject technology requires some prior installation of data on the GPS to allow locational prompting, but is more efficient and automatic. However, without the necessity of an internet connection in an outdoor setting, the GPS embodiment can make it easier to access in even remote outdoor locations, and still displays the information necessary and pertinent to the user. Without built-in markers, the user can automatically access information already installed in the GPS, without the need to have infrastructure such as signage in place.

Furthermore, the second embodiment can further decrease the granularity of data provided to the GPS system files by supplementing the new file that provides more accurate information to the user that is more specific to a localized location, not restricted to streets, landmarks and man-made infrastructure. This data can include locations where GPS can be rendered (previously) ineffective, in places not limited to shopping malls, museums and exhibitions, visitor centers. The data presented may also be in the future used to provide the GPS with information not only on the X-Y coordinate plane as is currently available, but also in a vertical “Z” direction, with data points being given at a certain elevation, and providing information about each elevation (in buildings, such as skyscrapers, towers, and so on). The potential to access such information proves the ability for this method to be flexible and current and enables new developments to continue to be compatible with the GPS application provided herein.

Thus, instead of using traditional methods of internet browsing apart from initially accessing the site, the subject technology reduces the amount of time wasted searching for relevant and important information. The system can be employed in many different outdoor areas, such as recreation centers, nature trails, arboretums, preserves, historic sites, and parks, shopping plazas, malls, and visitor centers, which can be used for enjoyment and education, and the information file for the GPS can be downloaded either wirelessly to an enabled GPS or through a cable.

Another embodiment of the subject technologies involves the user recognizing a visual location marker (12) where information can be downloaded. The visual marker will have an implemented data transfer capability, whether it be through a short range radio wave system (whether it be something like BlueTooth), through a WiFi-Internet capable system, or even through a corded data transfer system similar to the USB. With a system in place to recognize a user's gesture (such as the phone tapping the marker, or the phone being shaken or pulled toward the person in a gesture), the mobile device would be able to through a wire or wirelessly download data to the mobile device of the phone (13, 14). This embodiment would enable a person to, in a localized setting, access information that may be unable to be accessed in a location that does not have access to the internet directly (not limited to museums, arboretums or visitor centers, for example with built-in infrastructure for technology already in place). It would provide the user in that location with information that educates and provides pertinent information at the localized setting, without disrupting the experience of the user. This subtle use of gestures allows the visitor to access the information without the need for searching through directories to finding information, and enables them to voluntarily access the information, whether they would prefer to find out more information, or not.

The system provides the most accessible information, without the need of the user to access it as an obligation, and allows them to access the information consistently with the same gesture at any marker in the information system. Further, with short range access points, there is no problem associated with providing the user with the incorrect data of a different site than the one they wanted. This third iteration provides the user with a subtle, and voluntary, approach to receiving information at a closer range and provides a less invasive and smaller range of information access.

The present document discloses several techniques for providing location based information to a user. The location based information may include, e.g., information such as hiking and trail information that may be used by outdoor users who are at a location not covered by GPS technologies.

In some embodiments, techniques for providing location based information to users of wireless devices include, receiving, from the wireless device, a request for a web page; and providing, the web page to the wireless device, wherein the web page includes information specific to a location of the wireless device and wherein the location-specific information is provided without receiving a location signal (e.g., GPS coordinates, or wireless network-provided location information, from the wireless device. In some embodiments, the web page includes information pertaining to the user's altitude or elevation. In one example aspect, a user may be positioned in a multi-storied building. All floors of the multi-storied building, e.g., may indicate the same GPS location due to the inability of GPS signal to indicate altitude information. The web pages provided to the user may be designed to provide information in a relatively short geographic range at a given elevation (e.g., a particular floor of an office building). Without the user or the user's device having to explicitly communicate elevation information (e.g., I am on floor 6), the URL requested by the user's device is related to a barcode or a QR code that is in the user's proximity, which in turn, is tied to the user's location in 3-dimensional space.

From the foregoing descriptions and drawings, it is apparent each of the applications have unique merits in terms of automation, wireless use and variances in methods of usage. The wireless application of technologies is especially useful because of its minimal impact to the environment in terms of consumption of paper, and the lack of necessity in requiring further interpretive signs and information. With the ubiquity of a various number of mobile devices, the use document provides the user of an outdoor place the ability to access information quickly and easily, in a multitude of ways.

While the methods herein described, and the forms of apparatus for carrying these methods into effect, constitute preferred embodiments of the disclosed technology, with regards to the subject technology being implemented in an outdoor setting it is to be understood that the subject technology is not limited to these precise methods and forms of apparatus and can be implemented elsewhere, and changes can be made without departing from the scope of the invention which is defined in the appended claims. In some embodiments, the disclosed techniques, operational steps and methods may be performed using a combination of hardware or software that may be implemented on special purpose processors or general processors or using electronic circuits. In some embodiments, the disclosed techniques may be embodied as a computer program product having code stored thereon, the code, when executed, causing a processor to implement various described operations and functions. The disclosed techniques may be embodied using mobile phones, smartphones, tablet computers, etc. and using wireless communication technologies such as IEEE wireless standards (802.x), wide area cellular technologies including, but not limited to, 2G, 3G and 4G technologies.

What is claimed is:

1. A method of accessing information in an unfamiliar outdoor or highly localized setting using readily available wireless infrastructure, and providing a method of combining disparate technologies into a single application, following the steps of:
1. Configuring a physical or virtual marker accessible to a visitor in the area.
2. Allowing a user access to information from the mobile device
3. Providing the user's device location-pertinent information.

2. The method of claim 1 wherein the step of providing user information comprises providing the information without an explicit request from the user.

3. A method to provide the user with pertinent information wirelessly and directly prior to and on location, to plan their experience, without the user's active effort.

4. A method of claim 1, provides relevant resources such as points of interest and trail information quickly and efficiently, allowing information to be manually or automatically retrieved to the user.

5. A method that, as noted in claim 1, configures a system that, even without a knowledge of a user's geographic presence, is still be able to provide information.

6. A method as defined in claim 1 that streamlines all information into pertinent information, providing only important and significant data that is of use to the user at that point.

7. A method of claim 1 that allows the information presented online for viewing to be edited online, and allow the changes to be reflected when the user accesses the information.

8. A method as defined in claim 1, wherein all three steps can be used an unfamiliar outdoor or highly localized setting as a method to access the following, not limited to:
1. Visitor/User safety information
2. Distance to a point of interest
3. Interpretive Programs
4. Trailhead information
5. Trail closures
6. Weather warnings

9. A method of enhancing the granularity of the GPS, including information not provided by the GPS database, and supplementing information to the user at a location without preexisting corresponding information, following the steps:
1. Creating a file that is accessible online that is able to be downloaded to a GPS by a user, both wirelessly or through a cable connection.
2. On the GPS based on a user's location and the information on the file, the GPS provides further information regarding the points.

10. A method of claim 8, provides information to the user without an explicit request to the user, which gives the user the option to view data that supplements the GPS's built-in data files.

11. A method of claim 8 that allows a file to supplement built-in geographic data of the GPS to enable the user to access more localized data from the internet on their mobile device.

12. A method of claim 8 that requires no internet connection to access information that primarily is found online.

13. A method of claim 8 that is able to be expanded to not only outdoor uses, but for any location that does not provide information to user at more localized and specific locations without information markers, including but not limited to shopping malls, museums, buildings.

14. A method of claim 8 that can later supplement data already presented on a GPS, for example in the X-Y coordinate plane with information presented at elevations on the X-Y-Z coordinate plane.

15. A method of claim 8 that is flexible and can be modified and updated with current features that are necessary of the device and provided because of the user's necessity

16. A method of providing the user with the ability to access information through gestures performed with the phone through the following steps:
1. Creating a system that is enabled by short distance wireless or cord transfer of information to a user's phone.
2. Placing a visual marker that allows the user to recognize the location or nearby vicinity (less than 6 feet) as a point of data transfer.
3. If it is a wireless transfer site, enabling data to be transferred by the user's gesture involving the user's phone, whether it be related to, for example, tapping the phone on the marker or performing the gesture through the air.
4. If it is a site with a point of access through a wire, allowing the visitor to transfer the data to their phone using a data transfer hub for commonly used mobile devices.

17. A method of claim 16 that provides a subtle and an unobtrusive system where the user is given access to information without the obligation of accessing, or even downloading, information; In other words, enabling users to access information only when they require or desire it.

18. A method of claim 16 in a system that provides certain information in a relatively short proximity, without overlapping data transfers from two competing sources, which accurately provides information to the users that is pertinent to their present location when performing gestures.

19. A method of claim 16 that provides a wire or wireless source of data that is found on a marker (whether it be an information sign, museum directory, and so on) located in the proximity of the potential user.

20. A method of claim 16 that provides access to data without the need for internet directly connected to the user's mobile device.
